(19) United States
(12) Patent Application Publication
(10) Pub. No.: US 2008/0256551 A1
(43) Pub. Date: Oct. 16, 2008

(54) System and Method For Storing State Information

(75) Inventors: Michael Priel, Hertzelia (IL); Dan Kuzmin, Givat Shmuel (IL); Leonid Smolyansky, Or Akiva (IL)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: FREESCALE SEMICONDUCTOR. INC.

(21) Appl. No.: 12/067,587

(22) PCT Filed: Sep. 21, 2005
(86) PCT No.: PCT/IB2005/053108

§ 371 Date: Mar. 20, 2008

(51) Int. Cl. G06F 9/46

(52) U.S. Cl. 718/108

(57) ABSTRACT

A method for storing state information, the method includes storing, at a first circuit, state information representative of a state of a second circuit while the second circuit enters a low power mode; characterized by receiving an indication that a task switching from a first task to a second task should occur; storing a state information representative of a state of the second circuit, at the first circuit; receiving an indication that the first task should be resumed; and writing the stored state information from the first circuit to the second circuit. A system includes a first circuit and a second circuit, whereas the first circuit is connected to the second circuit and is adapted to store state information representative of a state of a second circuit; characterized by including a controller adapted to control a storage of the state information if at least a portion of the second circuit is powered down or if the second circuit is associated with a task switching operation.

### FIELD OF THE INVENTION

The present invention relates to systems and methods for storing state information, especially in multitasking systems.

### BACKGROUND OF THE INVENTION

Many modern processors and controllers are able to execute multiple tasks and to jump from one task to the other by performing task switching operations. Typically, a task switching occurs when a high priority task pre-empts a lower priority task that is currently executed. Such high priority tasks can be associated with interrupts, but this is not necessarily so.

Once a task switching operation occurs the state information representative of a state of a processor (or a portion of the processor) prior to the task switching operation is saved in order to facilitate task recovery. Thus, once the higher priority task is completed the processor can continue to execute the lower priority task.

Typically, task switching operations require to store the state information at a separate memory unit. Such a solution is illustrated in U.S. Pat. No. 6,898,700 of Alexander III et al., which is incorporated herein by reference. This operation is relatively time consuming. Another hardware extensive task switching supporting system and method is described at U.S. Pat. No. 6,671,762 of Soni et al., which is incorporated herein by reference.

There is a growing need to find effective systems and methods for storing state information.

### SUMMARY OF THE PRESENT INVENTION

A system and a method for storing state information, as described in the accompanying claims.

### BRIEF DESCRIPTION OF THE DRAWINGS

The present invention will be understood and appreciated more fully from the following detailed description taken in conjunction with the drawings in which:

FIG. 1 is a schematic illustration of a system, such as an integrated circuit, according to an embodiment of the invention;

FIG. 2 illustrates a portion of a system, according to an embodiment of the invention;

FIG. 3 illustrates a portion of a system, according to another embodiment of the invention;

FIG. 4 illustrates a portion of a system, according to a further embodiment of the invention;

FIG. 5 illustrates a portion of a system, according to an embodiment of the invention;

FIG. 6 is a timing diagram illustrating a utilization of the first circuit, according to an embodiment of the invention;

FIG. 7 is a timing diagram illustrating a task switching operation, according to an embodiment of the invention;

FIG. 8 is a flow chart of a method for storing state information, according to an embodiment of the invention;

FIG. 9 illustrates a first circuit utilizing stage 350, according to an embodiment of the invention; and

FIG. 10 illustrates a flow chart of a method 400 for storing information, according to another embodiment of the invention.

### DETAILED DESCRIPTION OF PREFERRED EMBODIMENTS

Many systems include low power state retention circuits. A low power state retention circuit (also referred to as a first circuit) stores the state of another circuit (also referred to as a second circuit) that is shut down during a low power mode. The selective shutting down of the second circuit decreases the aggregate power consumption of the system.

According to an embodiment of the invention the low power state retention circuits are also utilized for task switching purposes. Conveniently, this is enabled by altering the control of the low power state retention circuit.

According to an embodiment of the invention the low power state retention circuit is a part of a component that also includes the second circuit. For example, various registers that form a part of a processor can also include (or are connected to) low power state retention circuits that also belong to the processor.

Conveniently, the low power state retention circuit is isolated from the second circuit. Thus, after the state of the second circuit is stored the first circuit is isolated from the first circuit. Then, the task switching from a first task to a second task can be completed. After the second task is completed the state information can be restored from the first circuit and the execution of first task can continue.

According to yet another embodiment of the invention the first circuit can store state information relating to multiple states of the second circuit. Conveniently, this enables task nesting.

According to an embodiment of the invention a first circuit that is adapted to store state information relating to multiple states includes circuits that are used for both task switching and low power state retention purposes as well as components that are used for task switching only.

It is noted that although the following examples refers to NMOS and PMOS transistors this is not necessarily so as transistors that are manufactured by other processes can be represented by reference circuits.

The following examples refer to a low power mode as well as another power consuming operational mode. It is noted that the method can be applied, mutatis mutandis, to an integrated circuit in which there are multiple operational modes that are characterized by different power consumption level.

According to an embodiment of the invention the first circuit and the second circuit include a relatively limited amount of transistors. This limited amount of transistors form few logic gates.

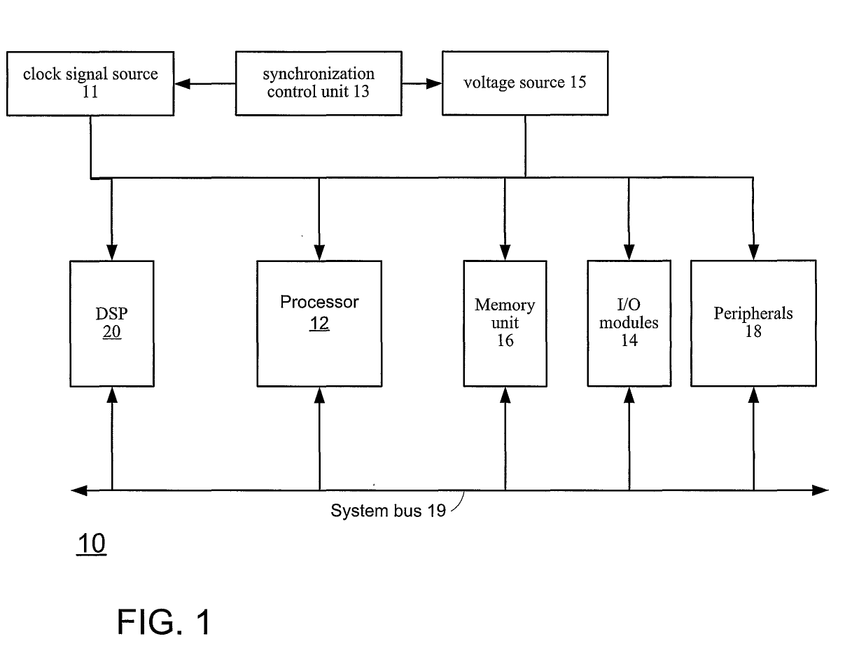

FIG. 1 is a schematic illustration of a system, such as an integrated circuit, 10 that includes various components, according to an embodiment of the invention. Each component may include a large number of low power state retention circuits, according to an embodiment of the invention.

System 10 includes various components such as general purpose processor 12, I/O module 14, memory unit 16, peripherals 18, and digital signal processor (DSP) 20. These components are linked to each other by various lines and buses and receive clock signals and power supply from one or more sources, such as clock signal source 11 and voltage source 15.

Optionally, the clock signal source 11 and the voltage source 15 are also connected to a synchronization control unit 13 that matches between the clock frequency and supplied voltages, such as to prevent a case in which the voltage supplied to and components is too low to support the clock frequency of the clock signal. This matching is useful when altering the operational mode of the integrated circuit and applying DVFS techniques.

Typically, system 10 includes multiple busses and lines and the various components of system 10 can be connected to the same bus, but this is not necessarily so. For convenience of explanation FIG. 1 illustrates a system bus 19 that is shared by components 12, 14, 16, 18 and 20.

Each of these components, but usually processor 12 or DSP 20, can include one or more (usually a large amount of) first circuits 110 and second circuits 120.

It is noted that system 10 can have various configurations and that the components illustrated in FIG. 1 represent only a single exemplary configuration of a system that applies the mentioned below methods. Typically, system 10 is included within a mobile component such as a cellular phone.

Modern integrated components such as processor 12 and DSP 20 can include millions of transistors. System 10, or at least some of its components (such as but not limited to processor 12 and DSP 20) can operate in various operational modes, including low power modes such as but not limited to an idle mode or standby mode. During a standby mode it is desired to reduce the power consumption of a component, especially in view of the low computational load imposed on said component during said mode.

Typically, processor 12 supports task switching. Typically, once a task is switched the state of at least some portion of processor 12 should be stored. The portion can be determined in response to the task that is being pre-empted, but this is not necessarily so.

According to an embodiment of the invention the storage (and retrieval) of information indicative of a state of the second circuit (also referred to as state information) is controlled by signals that indicate the reason for performing the storage (and retrieval) operations, For example, one control signal can indicate the power mode of the system (or a portion of the system) and another control signal can indicate that a task switching occurs.

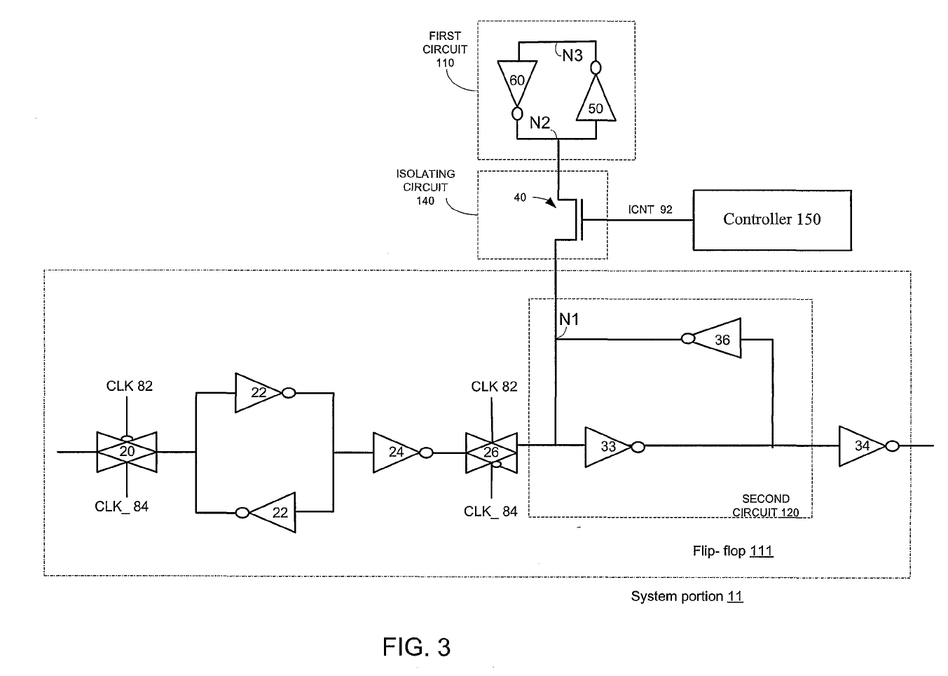

According to another embodiment of the invention the storage (and retrieval) of information indicative of a state of the first circuit (also referred to as state information) is controlled by signals that do not indicate the reason for performing the storage (and retrieval) operations. For example, FIG. 3 illustrates a control signal CNT 92 that merely opens or closes an isolating circuit 140 such as to read or write state information.

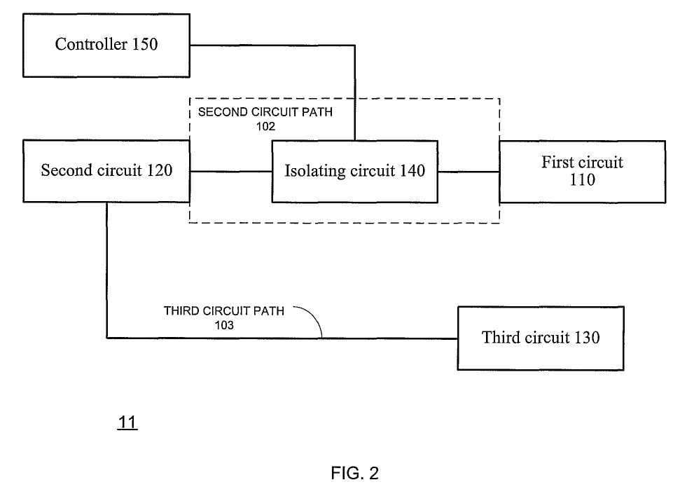

According to various embodiments of the invention the first and second circuits are controlled locally or by a centralized component, such as controller 150 of FIG. 2. The controller 150 can be provided for each flip-flop, for a group of flip-flops and even for larger groups of multiple components. The controller can include hardware and/or software components and can be a part of processor 12, although this is not necessarily so.

By using power gating techniques the system 10 can shut down many transistor-based circuits, such as but not limited to memory circuits, logic gates and the like, thus reducing the power consumed during standby mode. In some case substantially the whole memory circuit is shut down but in other cases only a portion of the memory circuit is shut down.

FIG. 2 illustrates a portion 11 of system 10, according to an embodiment of the invention.

Portion 11 includes second circuit 120, isolating circuit 140, first circuit 110, third circuit 130 and controller 150. The isolating circuit 140 is connected between the first and second circuits 110 and 120. The isolating circuit 140 as well as the conductors between this circuit and the first and second circuits form a second circuit path 120 that is conveniently very short. According to an embodiment of the invention the second circuit path does not include inter-component conductors.

The third circuit 130 is connected to the second circuit 120 via a third circuit path 103 that is usually much longer that the second circuit path 102 and usually includes inter-component conductors as well as intra-component conductors that least from the second circuit 120 to an interface between the component that includes the second circuit 120 and an inter-component conductors such as system bus 19.

The controller 150 controls the operation of at least the isolating circuit 140, although it can also control the first circuit 110 and/or the second circuit 120, conveniently by sending control signals.

The first circuit 110 and the second circuit 120 can include portions of various prior art circuits, such as illustrated in the following patents and patent applications, all being incorporated herein by reference: U.S. patent application number 2004/0008056 of Kursun et al.; U.S. Pat. No. 6,169,419 of De et al.; U.S. patent application publication number 2004/0051574 of Ko et al; PCT patent application publication number WO 2004/021351A1 of Garg et al; U.S. Pat. No. 5,600,588 of Kawashima; U.S. patent application 2004/0227542 of Bhavnagarwala et al.; U.S. Pat. No. 6,755,180 of Biyani et al., and U.S. patent application publication number 2003/0061526 of Hashimoto.

According to an embodiment of the invention the first circuit 110 can be shut down (for example by not supplying power supply or by supplying lower than required power) when it does not store state information. On the other hand, it should be powered when it stores state information, even during low power mode. The selective power supply can be implemented by gating the power supplied to the first circuit 110. It is noted that if a system 10 aborts a task that was not completed and the first circuit stores state information of that task then it can be power down.

According to various embodiments of the invention the state information can be sent to the first circuit 110 as well as to a third circuit. For example, state information of a certain register within processor 12 can be sent to a third circuit 130 such as memory unit 16 during task switching. This can occur if the first circuit 110 already stores state information relating to a non-completed task. If, for example, processor 12 can perform nesting of K tasks, and the first circuit 110 can store information relating to G (G<K) tasks that information relating to (K-G) tasks can be sent to memory unit 12.

FIG. 3 illustrates a portion 11 of system 10, according to an embodiment of the invention. Portion 11 includes flip-flop 111 and controller 150.

The flip-flop 111 includes first transfer gate 20, second transfer gate 26, and inverters 22, 24, 33, 34 and 36. The isolating circuit includes transistor 40 and the first circuit 110 includes two inverters 50 and 60. A second circuit 120 includes inverters 33 and 36 that belongs to flip-flop 111.

An input node of first transfer gate 20 forms the input node of flip-flop 111. The output of the first transfer gate 20 is connected to first and a second inverters 22 that are connected in parallel to each other such that the input of one inventor is connected to an output of the second inverter. These two inverters 22 are connected to a third inverter 24 that in turn is connected to a second transfer gate 26.

The output of the second transfer gate 26 is connected to an input of a fourth inverter 33 at a first node denoted N1. The output of the fourth inverter 33 is connected to a fifth inverter 34 and to a sixth inverter 36. The output of the sixth inverter 36 is connected to N1.

The drain of transistor 40 is connected to N1. The source of transistor 40 is connected to a second node N2. The second node N2 is also connected to an input of seventh inverter 50 and to an output of a eighth inverter 60. The output of the seventh inverter 50 is connected to the input of the eighth inverter 60 at a third node N3. The seventh and eighth inverters 50 and 60 form a retention latch that is also referred to as first circuit 110.

The gate of transistor 40 receives a control signal ICNT 92 that determines when to open transistor 40 such as to allow state information to be sent to first circuit 110 or to be sent from the first circuit 110 to the second circuit 110. Signal ICNT 92 activates the transistor 40 during first circuit 110 read and write periods.

ICNT 92 is asserted before entering a low power mode, or before performing a task switching such as to provide state information representative of the state of second circuit 120 and especially of first node N1. ICNT 92 is also asserted when there is a need to read said stored state information from the first circuit 110.

Once system 10, or at least portion 11, enters a low power mode flip-flop 111 is shut down, thus reducing the power consumption during the low power mode. This can be achieved by not supplying these circuits with any voltage or reducing the level of the supply voltage beneath a predefined non-operable threshold.

Transistor 40 is placed between the first and second circuits 110 and 120 for isolating these circuits from each other when it stores state information.

An NMOS transistor can be shut down by disconnecting it from a supply source, or by providing a low supply voltage to its gate. On the other hand an efficient shut down of a PMOS transistor may require to connect the gate of the PMOS transistor to a high level signal. Accordingly, using NMOS transistors can be more power efficient than using PMOS transistors.

According to an aspect of the invention only few transistors receive a supply voltage during the low power mode. Referring to the example set forth in FIG. 3, only the seventh and eighth inverters 50 and 60 receive a supply voltage (V_retention) during the low power mode.

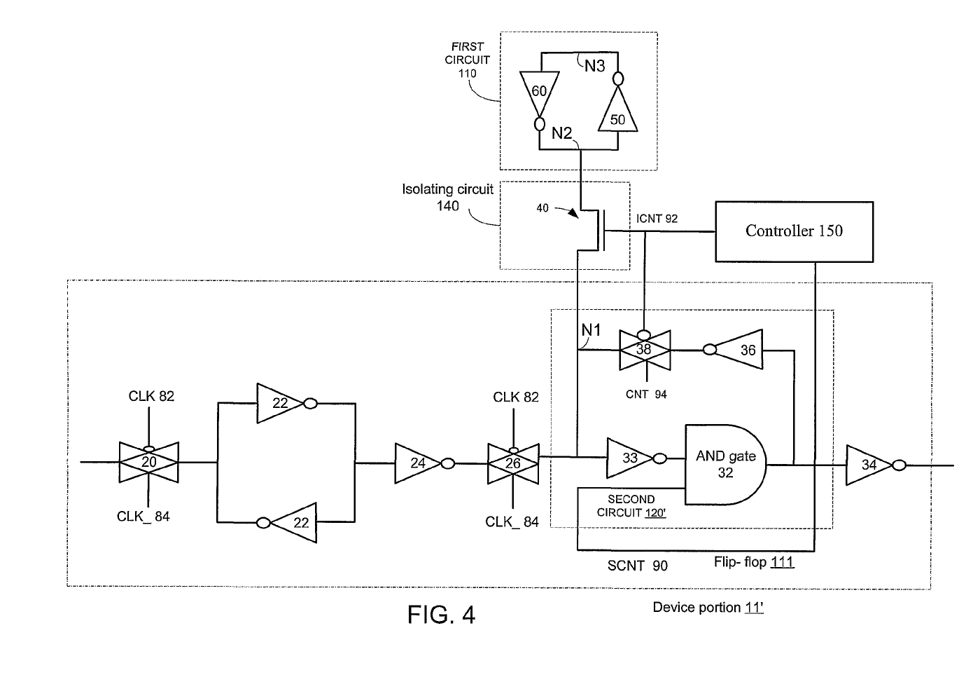

FIG. 4 illustrates a portion 11′ of system 10, according to an embodiment of the invention.

Flip-flop 111′ (and especially second circuit 120′) of FIG. 4 differ from flip flop 111 (and especially second circuit 120) of FIG. 3 by including elements that allow selective writing of state information from the first circuit 110. In a nut shell, flip flop 111′ overcomes limitations of the writing process from the first circuit 110 via the isolating circuit 140 to the second circuit 120′ by providing a default value that can be selectively overwritten by state information provides from the first circuit 110.

Conveniently, transistor 40 is a NMOS transistor and provides a good pull down path but provides a less efficient pull up path. Thus, the default value provided to node N1 is high. If transistor 40 was a PMOS transistor then the default value should be low.

The second circuit 120′ includes fourth inverter 33, AND gate 32, sixth inverter 36, and a third transfer gate 38. The output of the fourth inverter 33 is connected to a first input of an AND gate 32. The output of the AND gate 32 is connected to the fifth inverter 34 and to the sixth inverter 36. The output of the fifth inverter 36 is connected to a third transfer gate 38. The output of the third transfer gate 38 is connected to N1.

While the first and second transfer gates 20 and 26 receive a clock signal CLK 86 and an inverted CLK signal (CLK_) 84, the third transfer gate 38 receives control signal ICNT 92 and an inverted ICNT signal (CNT) 94.

The isolating circuit 140 includes a transistor such as NMOS transistor 40. NMOS transistors are frequently used as switches or as conveying (transferring) components. Typically, data is selectively passed between an NMOS transistor source to its drain (or vise verse). NMOS transistors pass low level signals (“0”) without affecting them, but have a negative affect on high level signals (“1”).

When an NMOS transistor receives a high level signal it provides a reduced output signal. The reduction is substantially equal to the threshold voltage Vₜ of the transistor. PMOS transistors pass high level signals without affecting them but increase the level of low level signals. Accordingly, NMOS transistors are placed in pull down circuit, while PMOS transistors are placed in pull up circuits.

According to an embodiment of the invention the NMOS transistor 40 will write to first node N1 only if the first circuit 110 stores a low level state information. If the first circuit 110 stores high level state information the second circuit 120, and not transistor 40, will provide a high level signal to first node N1. This high level state information is provided by providing a control signal SCNT 90 to the input of AND gate 32.

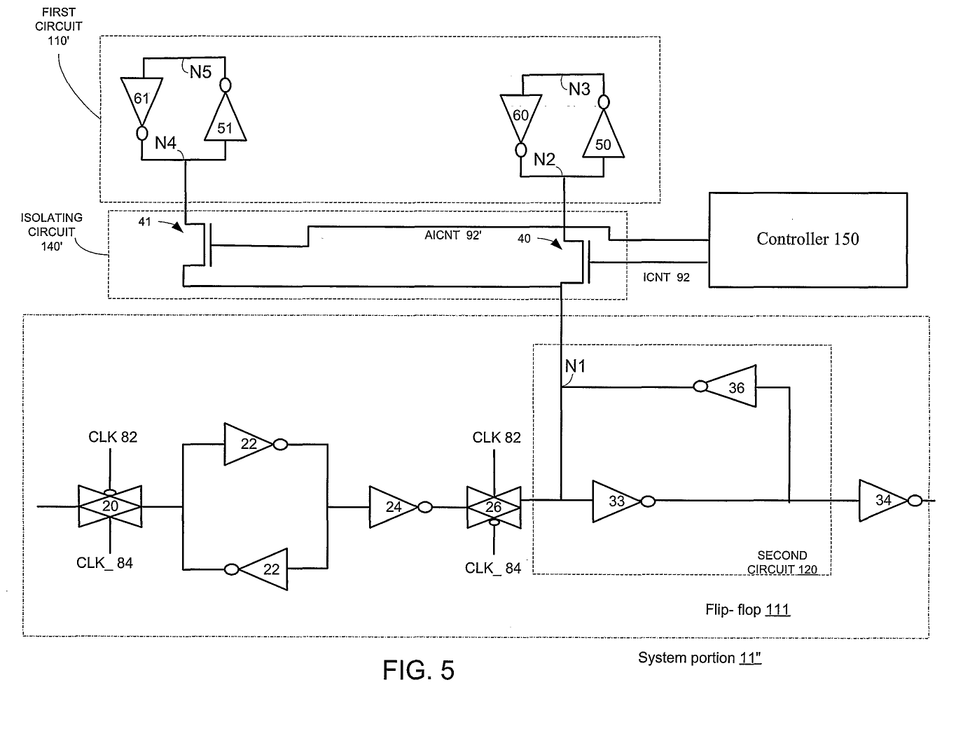

FIG. 5 illustrates a portion 11″ of system 10, according to a further embodiment of the invention.

Isolating circuit 140′ of FIG. 5 differs from the isolating circuit 140 of FIG. 2 by having an additional transistor 41 that is connected to N1 in parallel to transistor 40.

First circuit 110′ of FIG. 5 differs from the first circuit 110 of FIG. 3 by having an additional latch that includes ninth inverter 51 and tenth inverter 61 that form an additional latch. A fourth node N4 is connected to an input of ninth inverter 51 and to an output of the tenth inverter 61. The output of the ninth inverter 51 is connected to the input of the tenth inverter 61 at a fifth node N5.

This additional latch as well as the latch formed of inverters 50 and 60 is an example of a memory circuit. FIG. 5 illustrates a portion 11″ that can select a memory circuit out of multiple memory circuit.

The additional transistor 41 is controlled by a control signal AICNT 92′, while transistor 40 is controlled by control signal ICNT 92.

Portion 11″ of system 10 includes flip-flop 111, isolating circuit 140′ and first circuit 110′. This portion 11′ can store state information representative of multiple states. This can utilized for task nesting.

According to an embodiment of the invention only one of the latches of first circuit 11′ is required for low power state retention while both latches can be used for task switching.

The operation of these circuits will be explained by the following example. It is assumed that processor 12 executes a first task and then determines that is has to switch to a second task. In such a case state information representative of the state of flip-flop 111 (before switching to the second task) is stored in a latch that includes the seventh and eighth inverters 50 and 60.

It is further assumed that before the second task is completed it is preempted by a third task. Before the processor 12 switches to the third task state information representative of the current state of flip-flop 111″ is stored in a latch that includes the eighth and tenth inverters 51 and 61. Once the third task is completed the state information from the ninth and tenth inverters 51 and 61 is written to the second circuit 120. Once the second task is completed the state information from the sixth and seventh inverters 50 and 60 is written to the second circuit 120.

If the processor 12 attempts to switch to a fourth task (while the other three tasks were not completed yet and not aborted), then the state information that represents the state of the second circuit 120 just before performing any of the mentioned above tasks can be sent to a third circuit 130, such as memory unit 16.

It is noted that although FIG. 5 illustrates a first circuit 110′ that is capable of storing state information relating to two different states the invention is not limited to only two states. For example, K latches and K isolating circuit transistor that are connected to the second circuit 120, as well as the provision of appropriate control signals, can enable storing K states (K can be greater than two).

It is further noted that first circuit 110′ can be connected to second circuit 120′ of FIG. 4.

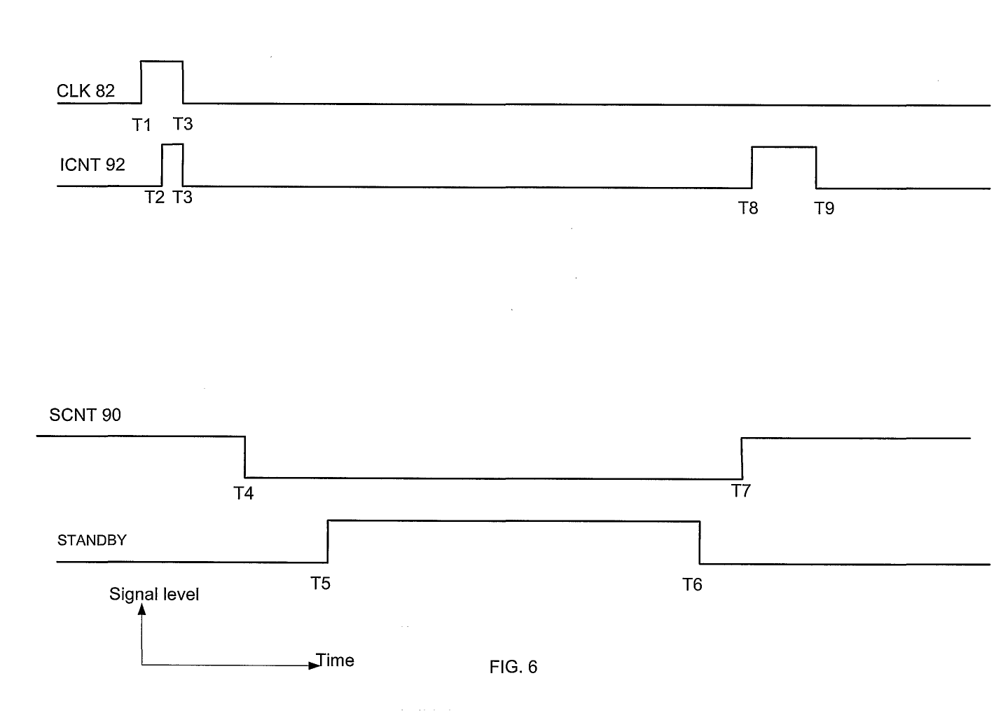

FIG. 6 is a timing diagram illustrating a utilization of the first circuit, according to an embodiment of the invention.

For convenience of explanation the timing diagram refers to the components illustrated in FIG. 4.

At time T1 the CLK 82 signal is asserted in order to allow data to pass through the first and second transfer gates 20 and 26. This will cause the data (state information) that is inputted to flip-flop 111 to be written to first node N1. CLK 82 is negated at T3.

At T2 ICNT 92 is asserted and CNT 94 (not illustrated in FIG. 6) is negated. The provision of high level ICNT 92 to the gate of transistor 40 as well as to the third transfer gate 38 writes the data at node N1 to the first circuit 110. ICNT 92 is negated at T3.

At T4, after both CLK 82 and 92 are negated, SCNT 90 is negated.

If the state information was written as a low power state retention stage then at T5 flip-flop 111, second circuits 120 enters a low power mode. During this mode only the first circuit 110 receives a supply voltage that allows it to store the received state information. An intent to enter the low power mode can be indicated by an assertion of a STANDBY signal.

Second circuit 120 exits the low power mode at T6. The exit from the low power mode can be indicated by a negation of a STANDBY signal.

Between T6 and T7 SCNT 90 and ICNT 92 are still low. The low level SCNT 90 signal forces AND gate 32 to output a low level signal at its output. This signal is inverted by sixth inverter 36. The sixth inverter 36 provides a high level signal, via third transfer gate 38, to the first node N1. In other words, the first node N1 is set to a default value.

The high level signal is inverted by the fourth inverter 33 and provided to the first input of AND gate 32. AND gate 32 receives two low level signals at its inputs and output a high level signal before data is restored from the first circuit 110.

At T7 SCNT 90 is asserted and at T8 and ICNT 92 are asserted. This wakes up transistor 40. If the data that is stored at the first circuit 110 is “1” then transistor 40 receives a high level signal at his source and at drain and does not write the high level signal into the first node N1. Thus, the second circuit 120′ remains in a default state.

If the data that is stored at first circuit 110 is low then transistor 40 acts as a pull down circuit and ground the first node N1. The AND gate 32 receives a high level signal at both its inputs and outputs a high level signal.

After a while (at T9) ICNT 92 is negated and the transistor 40 is shut down. Thus, the first circuit 110 is disconnected from flip-flop 111′. SCNT 90 is high, thus the AND gate 32 acts as a transfer gate and outputs the signal that is provided to its first input.

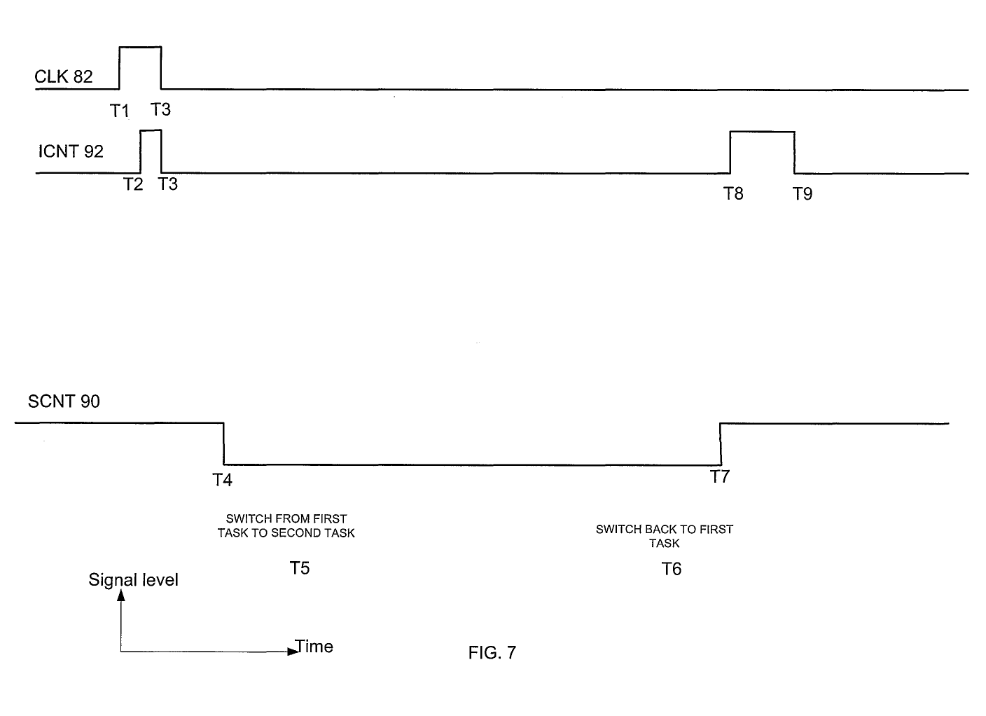

FIG. 7 is a timing diagram illustrating a task switching, according to an embodiment of the invention.

The timing diagram of FIG. 7 resembles the timing diagram of FIG. 6 but does not include the assertion or negation of a STANDBY signal, and neither includes power gating operations.

At about T5 a task switching from a first task to a second task occurs and at about T6 the system switches back to the first task.

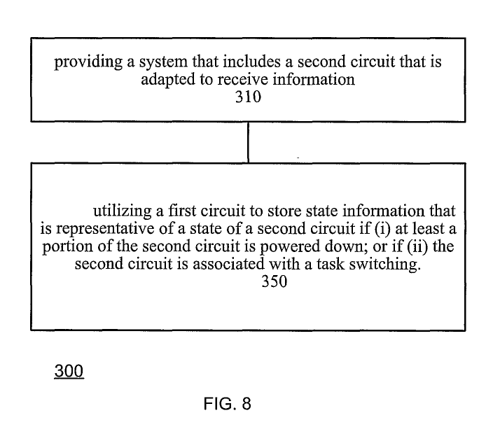

FIG. 8 is a flow chart of method 300 for storing state information, according to an embodiment of the invention.

Method 300 starts by stage 310 of providing a system that includes a second circuit that is adapted to receive information.

Stage 310 is followed by stage 350 of utilizing a first circuit to store state information that is representative of a state of a second circuit if (i) at least a portion of the second circuit is powered down; or if (ii) the second circuit is associated with a task switching. The second circuit is associated with a task switching if its state information should be stored when performing a task switching.

For example, when processor 12 performs a certain task switching operation the content of a first group of registers should be stored. If the second circuit 120 belongs to one of these registers then its state information should be stored.

It is noted that the task switching operation and the powering down operations are not related to each other and can be executed independently from each other. Typically a task switching operation takes place when at least a part of the device operates in a high power consuming mode.

The utilizing includes writing state information to the first circuit, storing the state information at the first circuit and reading the state information from the first circuit. According to an embodiment of the invention the read operation is responsive to the value of state information that is stored at the first circuit.

Conveniently, the stage 350 of utilizing is characterized by a short state information writing period. In other words, the state information is quickly provided from the second circuit to the first circuit. This length of the writing period can be few clock cycles, one clock cycle and even a fraction of a clock cycle.

According to an embodiment of the invention the first circuit 110 includes multiple memory circuits and stage 350 of utilizing includes selecting a memory circuit out of multiple memory circuits to store the information and also includes selecting from which memory circuit to read the information.

Conveniently, the stage of utilizing 350 includes determining whether to overwrite information stored in the first circuit. State information can be overwritten in various cases, such as if the state information relates to a task that was aborted after the related state information was stored in the first circuit.

Conveniently, stage 350 of utilizing includes sending the state information between the first circuit and the second circuit over a very short circuit path.

Conveniently, stage 350 of utilizing includes controlling an isolating circuit that is connected between the first and second circuits such as to facilitate storage of information in the first circuit.

Conveniently, stage 350 of utilizing includes determining when to provide power to the first circuit. This first circuit can be disconnected when it is not required—when a task switching operation does not occur, is not expected to occur or when the flip-flop 111″ operates at a mode that differs from standby or other low power mode. It is further noted that power is not provided to various components of flip flop 111′ or 110 during low power modes.

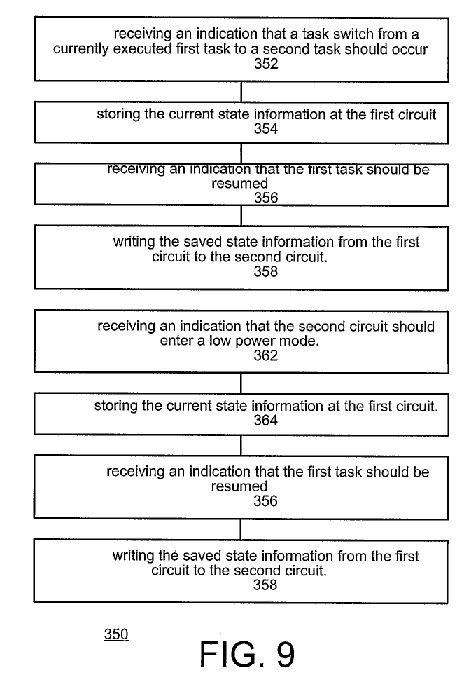

FIG. 9 illustrates a first circuit utilizing stage 350, according to an embodiment of the invention.

Stage 350 starts by stage 352 of receiving an indication that a task switching from a currently executed first task to a second task should occur.

Stage 352 is followed by stage 354 of storing the current state information at the first circuit.

According to various embodiments of the invention stage 354 includes sending the state information between the first circuit and the second circuit over a very short circuit path. Conveniently, stage 354 includes controlling an isolating circuit connected between the first circuit and the second circuit such as to facilitate a storage and a retrieval of state information.

Conveniently, stage 354 includes determining when to provide power to the first circuit.

It is noted that after stage 354 ends and before stage 356 starts a system that includes the second circuit can execute the second task.

Stage 354 is followed by stage 356 of receiving an indication that the first task should be resumed.

Stage 356 is followed by stage 358 of writing the saved state information from the first circuit to the second circuit.

Stage 358 is followed by stage 362 of receiving an indication that the second circuit should enter a low power mode.

Stage 362 is followed by stage 364 of storing the current state information at the first circuit.

It is noted that after stage 364 ends and before stage 366 starts the second circuit enters a low power mode. This is illustrated by stage 365 of executing the

Stage 364 is followed by stage 366 of receiving an indication that the second circuit should exit the low power mode.

Stage 366 is followed by stage 368 of writing the saved state information from the first circuit to the second circuit.

It is noted that the order of these stages can be changes without departing from the scope of the invention. For example, stages 362-368 can be executed before stages 352-358.

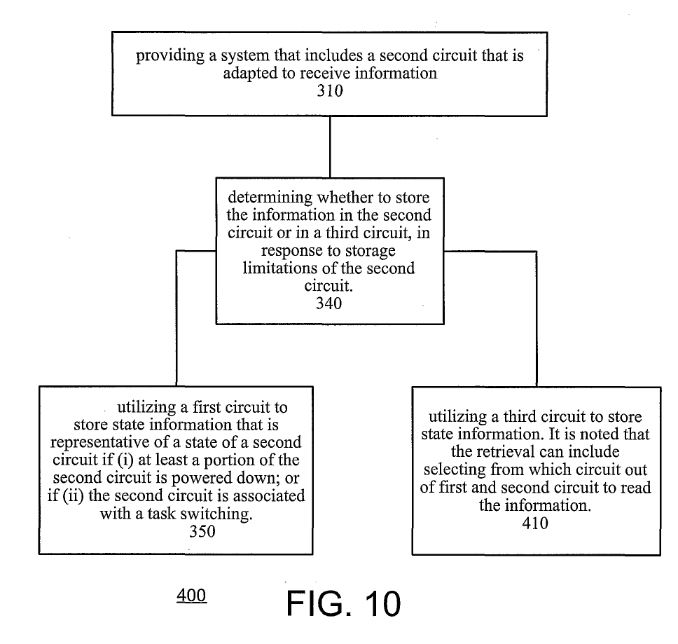

FIG. 10 illustrates a flow chart of a method 400 for storing information, according to an embodiment of the invention.

Method 400 differs from method 300 by including stage 340 of determining whether to store the information in the second circuit or in a third circuit, in response to storage limitations of the second circuit. If the state information should be stored in the first circuit then stage 340 is followed by stage 350. Else, stage 340 is followed by stage 410 of utilizing a third circuit to store state information. It is noted that the retrieval can include selecting from which circuit out of first and second circuit to read the information.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the following claims.

1. A method for storing state information, the method comprises
storing, at a first circuit, state information representative of a state of a second circuit while the second circuit enters a low power mode;
receiving an indication that a task switching from a first task to a second task should occur;
storing, at the first circuit, state information representative of a state of the second circuit;
receiving an indication that the first task should be resumed; and
writing the stored state information from the first circuit to the second circuit.

2. The method according to claim 1 further comprising determining whether to store the information in the second circuit or in a third circuit, in response to storage limitations of the second circuit.

3. The method according to claim 1 wherein the storing is characterized by a short state information writing period.

4. The method according to claim 1 wherein the first circuit comprises multiple memory circuits and the storing comprises selecting a memory circuit out of multiple memory circuits to store the state information.

5. The method according to claim 1 wherein the storing comprises determining whether to overwrite state information stored in the first circuit.

6. The method according to claim 1 wherein the storing comprises sending the state information between the first circuit and the second circuit over a very short circuit path.

7. The method according to claim 1 wherein the storing comprises controlling an isolating circuit coupled between the first circuit and the second circuit such as to facilitate a storage and a retrieval of state information.

8. The method according to claim 1 wherein the storing comprises determining when to provide power to the first circuit.

9. The method according to claim 1 wherein the first circuit and the second circuit comprise a limited amount of transistors.

10. A system comprising:
a first circuit and a second circuit, wherein the first circuit is coupled to the second circuit and is adapted to store state information representative of a state of a second circuit;
a controller adapted to control a storage of the state information if at least a portion of the second circuit is powered down or if the second circuit is associated with a task switching operation.

11. The system according to claim 10 wherein the controller is adapted to determine whether to store the state information in the second circuit or in a third circuit, in response to storage limitations of the second circuit.

12. The system according to claim 10 wherein the first circuit and the second circuit are very close to each other.

13. The system according to claim 10 wherein the first circuit comprises multiple memory circuits adapted to store state information representative of multiple states.

14. The system according to claim 10 wherein the controller is adapted to determine whether to overwrite state information stored in the first circuit.

15. The system according to claim 10 wherein an isolating circuit is coupled between the first circuit and the second circuit.

16. The system according to claim 10 wherein the controller is adapted to determine when to provide power to the first circuit.

17. The system according to claim 10 wherein the second circuit is adapted to provide a default state information that can be selectively overwritten by state information stored in the first circuit.

18. The method according to claim 1 wherein the utilizing comprises determining when to provide power to the second circuit.

19. The system according to claim 10 wherein the controller is adapted to determine when to provide power to the second circuit.

20. The method according to claim 2, wherein the storing is characterized by a short state information writing period.
